(19) United States
(12) Patent Application Publication
(10) Pub. No.: US 2025/0295210 A1
(43) Pub. Date: Sep. 25, 2025

(54) WALLET WITH AN INTEGRATED BOTTLE OPENER

(71) Applicant: Total Bullstrap LLC, Boca Raton, FL (US)

(72) Inventor: Claudio Conte, Boca Raton, FL (US)

(21) Appl. No.: 19/088,073

(22) Filed: Mar. 24, 2025

Related U.S. Application Data
(60) Provisional application No. 63/569,002, filed on Mar. 22, 2024.

(51) Int. Cl. A45C 11/18; B67B 7/16

(52) U.S. Cl. CPC A45C 11/182; B67B 7/16; A45C 2011/186

(57) ABSTRACT

A card holder wallet is disclosed. The wallet includes a main body having a front surface and a rear surface, with a pocket disposed therebetween for storing cards. A bottle opener is integrated into the rear surface of the main body and includes a rigid insert with an aperture having an arcuate edge configured to engage a bottle cap. A magnetic attachment assembly, comprising a plurality of magnets arranged in a predefined pattern, is embedded within the main body. In some embodiments, the rigid insert includes a raised platform surrounding the aperture, and the magnetic attachment assembly is positioned adjacent to the bottle opener. Additional features may include an intermediate casing, a filler layer, and an RFID-blocking layer. The wallet provides a compact and multi-functional design, combining card storage, bottle opening functionality, and magnetic attachment features within a slim and durable structure.

### REFERENCE TO RELATED APPLICATIONS

This application is a non-provisional patent application that claims the benefit of U.S. Provisional Appl. No. 63/569,002, titled “WALLET WITH AN INTEGRATED BOTTLE OPENER”, and filed on 22 Mar. 2024, the subject matter of which is hereby incorporated by reference.

### CROSS-REFERENCES

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISK

Not applicable.

### TECHNICAL FIELD

The present disclosure relates to the field of personal accessories, and more specifically to the field of wallets.

### BACKGROUND OF THE INVENTION

Historically, wallets have been developed primarily to secure and organize financial instruments such as currency, credit cards, and identification documents. Despite the utility provided by traditional wallets, users frequently encounter limitations regarding functionality and security, especially in the context of modern lifestyles that demand greater versatility and protection. The evolution of wallet designs has been marked by incremental advancements aimed at enhancing capacity, durability, and aesthetic appeal. However, these designs often overlook the integration of additional utilities that could significantly enhance user convenience. One such utility is the incorporation of tools like bottle openers, which, despite their frequent necessity in various social and domestic settings, typically necessitate carrying separate items, thereby contributing to bulk and inconvenience.

Moreover, the advent of digital technology and the increasing reliance on electronic payment systems have ushered in new challenges related to data security. Traditional wallets offer limited protection against modern threats such as unauthorized scanning and electronic theft, particularly concerning cards equipped with RFID technology. This vulnerability exposes users to potential security breaches, underscoring the need for enhanced protective measures within wallet designs.

Additionally, the integration of functional elements such as metal components for tool incorporation poses design challenges, including maintaining the wallet's aesthetic integrity, ensuring compatibility with electronic devices, and preventing damage to stored items. These challenges highlight the necessity for design approaches that reconcile the addition of functional utilities with the preservation of the wallet's primary features and user convenience.

As a result, there exists a need for improvements over the prior art and more particularly for a wallet that seamlessly combines enhanced utility, including integrated tools like bottle openers, with advanced security features such as RFID-blocking capabilities. Such a wallet should also address the aforementioned design challenges, offering a solution that is both practical and aligned with contemporary user expectations. The development of a wallet embodying these principles would signify a significant advancement in the field of personal accessories, offering users a multifaceted product capable of meeting the diverse demands of modern life.

### BRIEF SUMMARY OF THE INVENTION

An apparatus, system, and method for card holder wallet is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a card holder wallet is disclosed. The card holder wallet comprises a main body having a front surface and a rear surface. A pocket is disposed between the front surface and the rear surface. A bottle opener is disposed within the rear surface of the main body. The bottle opener comprises a rigid insert positioned within the main body. An aperture is formed through the rigid insert and the rear surface. The aperture has an arcuate edge configured to engage a bottle cap. A magnetic attachment assembly is embedded within the main body. The magnetic attachment assembly comprises a plurality of magnets arranged in a predefined pattern. The magnetic attachment assembly is disposed between the bottle opener and the rear surface. The predefined pattern of the plurality of magnets in the magnetic attachment assembly is a substantially ring-shaped configuration. The rigid insert comprises a base plate having a first surface and a second surface. The first surface faces an interior of the main body and the second surface faces the rear surface of the main body. A raised platform is formed on the base plate and extends outwardly from the second surface of the base plate. The aperture is defined within the raised platform. The aperture includes a contoured edge shaped to engage a bottle cap. A catching lip is disposed along a portion of the contoured edge. The catching lip comprises the arcuate edge. The raised platform is substantially circular. The plurality of magnets is disposed in the predefined pattern substantially around the raised platform. An intermediate casing is disposed within the main body between the front surface of the main body and the first surface of the rigid insert. The intermediate casing comprises an exposed surface on a rear facing side of the intermediate casing. The exposed surface is configured to substantially align with the raised platform of the rigid insert and the exposed surface is visible through the aperture in the rigid insert.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a front view of a wallet with an integrated bottle opener, according to an example embodiment;

FIG. 1A is a back view of the wallet with an integrated bottle opener, according to an example embodiment;

FIG. 1B is a side view of the wallet with an integrated bottle opener, according to an example embodiment;

FIG. 2 is a diagram illustrating the layers of the wallet with an integrated bottle opener, according to an example embodiment;

FIG. 2A is a perspective view of the wallet without the back leather layer, according to an example embodiment;

FIG. 3 is a perspective view of a metal layer of the wallet with an integrated bottle opener, according to an example embodiment;

FIG. 4A is a side view of a metal layer of the wallet with an integrated bottle opener, according to an example embodiment;

FIG. 4B is a cross-sectional side view of the metal layer, according to an example embodiment;

FIG. 5 is a front view of a first substantially planar surface of the metal layer, according to an example embodiment;

FIG. 6 is a detailed front view of the first substantially planar surface, according to an example embodiment;

Like reference numerals refer to like parts throughout the various views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system that improves durability, utility, security, and aesthetics of a wallet. The disclosure introduces a unique combination of materials that enhances durability while maintaining aesthetic appeal. The outer leather shell, coupled with a molded plastic middle layer and a microfiber innermost liner, provides a robust structure that withstands daily wear and tear better than traditional wallets. This material composition not only ensures longevity but also offers a luxurious feel, elevating the user's experience.

Moreover, the incorporation of a bottle opener significantly increases the wallet's utility. Unlike prior attempts to integrate tools into wallets, which often result in increased bulkiness or compromised aesthetics, this design seamlessly incorporates the bottle opener without detracting from the wallet's sleek and compact form. The metal layer's design, featuring a first substantially planar surface with an opening and a catching lip, allows for efficient cap removal while maintaining the wallet's slim profile.

The wallet's design incorporates a filler layer that mates with the metal layer's second substantially planar surface. This design choice results in a filler surface that is substantially flush with the metal layer's first substantially planar surface, achieving a sleek and uninterrupted external appearance. This detailed design optimizes both functionality and aesthetics, making the wallet an exemplary model of how modern engineering and integration of features can significantly improve upon the limitations of prior art.

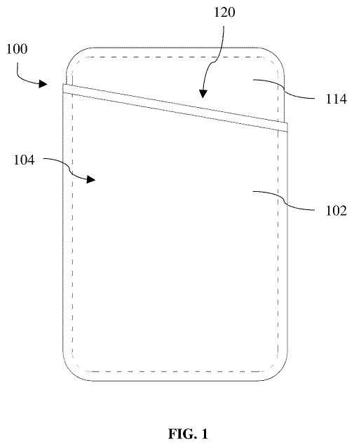

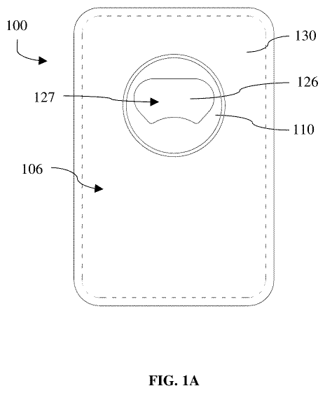

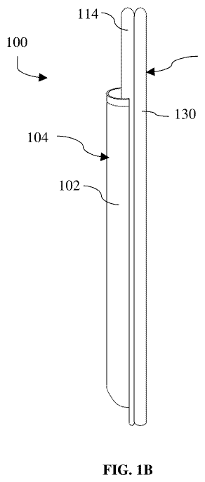

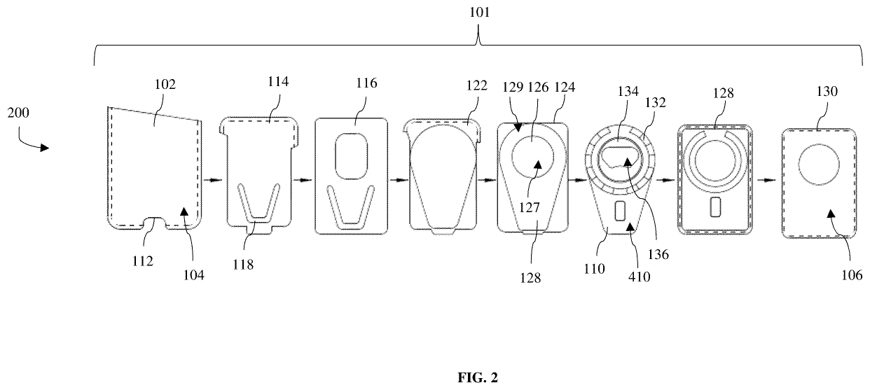

Referring now to the Figures, FIG. 1 is a front view of a card holder wallet 100 with an integrated bottle opener, according to an example embodiment. FIG. 1A is a back view of the wallet 100 with an integrated bottle opener, according to an example embodiment. FIG. 1B is a side view of the wallet 100 with an integrated bottle opener, according to an example embodiment. FIG. 2 is a diagram 200 illustrating the layers of the wallet 100 with an integrated bottle opener, according to an example embodiment.

The wallet 100 includes a main body 101 having a front surface 104 and a rear surface 106. The wallet also includes a bottle opener disposed within the rear surface of the main body. The main body includes an outer leather shell 102 including a front leather layer, a molded plastic middle layer, and a microfiber innermost liner. The wallet further includes a metal layer, or a rigid insert, 110. The metal layer is a distinct element of the wallet, configured to incorporate additional functionalities beyond conventional storage.

The outer leather shell, or outer casing, is the exterior part of the wallet, visible to the user and the first point of contact. Each layer within the outer leather shell is chosen for its specific properties, contributing to the shell's overall performance and aesthetic appeal. The front leather layer serves as the primary interface between the user and the wallet, offering a luxurious feel and high durability. Leather is renowned for its strength, flexibility, and ability to age gracefully, acquiring a unique patina over time. The choice of leather enhances the wallet's aesthetic appeal, making it a desirable accessory for discerning consumers. Positioned between the leather and microfiber layers, the molded plastic middle layer provides structural integrity and shape to the wallet. This layer is designed to be lightweight yet robust, ensuring the wallet retains its form even with extended use. The molding process allows for precise control over the wallet's dimensions and features, such as cutouts or reinforcements for additional functionalities.

The microfiber innermost liner serves multiple purposes, including cushioning the contents of the wallet, protecting the leather and plastic layers from wear, and offering a soft touch to the interior. Microfiber is chosen for its gentleness on sensitive items such as the delicate surfaces of cards, thereby protecting the wallet's contents, thus reducing the risk of scratches. Moreover, its inherent strength and resilience contribute to the wallet's longevity, safeguarding against wear and tear from daily use. The material's water-resistant properties also protect the wallet's contents from moisture, offering an added layer of security for items stored within. Other materials similar to microfiber, such as, but not limited to, felt, polyester, nylon, and cotton, may be used and are within the spirit and scope of the present disclosure.

The leather provides a durable and elegant exterior, the plastic layer ensures rigidity and durability, and the microfiber liner offers protection and a premium feel to the wallet's interior. This layered construction not only enhances the wallet's structural integrity but also its functionality, allowing it to protect and securely hold personal items.

The outer leather shell offers a balance between luxury and practicality. Traditional wallets often prioritize one aspect over the other, either focusing on aesthetic appeal with less durable materials or on durability with less attention to aesthetics. The described wallet, however, provides an optimal blend of both, ensuring longevity, functionality, and style. Moreover, the inclusion of a molded plastic layer is a distinctive feature that sets it apart from conventional wallets, offering enhanced durability and shape retention without significantly adding to the weight or bulk of the wallet. This layered construction methodology addresses common limitations in existing products such as wear and tear, and lack of structural integrity.

The outer leather shell has a cutout 112 on a bottom portion configured to assist with removing an object disposed in the wallet. This element is integrated into the wallet's structure to facilitate the easy removal of items, such as cards or currency, without compromising the wallet's overall aesthetic appeal or structural integrity. The cutout on the bottom portion of the outer leather shell is an opening designed to allow the user's finger to push upwards on an object stored within the wallet, thereby aiding in its removal. This feature addresses a common issue faced by many wallet users: the difficulty in retrieving items from tightly packed or deeply recessed compartments. This cutout is positioned in a location that is both intuitive for the user to find and effective in leveraging items out of the wallet. Its dimensions are calculated to be large enough to accommodate a finger's tip but small enough to maintain the wallet's contents securely. The edges of the cutout are smoothly finished to prevent any snagging on the contents or discomfort to the user.

The cutout functions as an ergonomic feature that enhances the user experience by simplifying the retrieval process. It interacts with the wallet's design by providing a direct and user-friendly means of accessing the wallet's contents, thereby reducing the time and effort needed to retrieve items. This feature is particularly beneficial in situations where quick access to the wallet's contents is necessary, such as during transactions or when identification is required. The inclusion of a cutout for assisting in the removal of objects improves over prior art, where the retrieval of items from a wallet can often be cumbersome and time-consuming. Traditional wallets lack such a feature, requiring the user to rely on pinching or shaking to access their contents. The introduction of this ergonomic cutout directly addresses this limitation, offering a simple yet effective solution that enhances user convenience. Furthermore, this feature integrates functionality into the fabric of its construction without detracting from its aesthetic appeal. This improvement over prior art highlights the wallet's commitment to user-centered design, setting a new standard for convenience and functionality in personal accessories.

The main body further includes a second leather layer 114 positioned adjacent to the outer leather shell and a spring bar layer 116 disposed next to the second leather layer. This configuration enhances the wallet's functionality, durability, and aesthetic appeal. The second leather layer acts as an intermediary component within the wallet, placed closely to the outer leather shell. It serves multiple purposes, including adding structural support, increasing the wallet's capacity for holding items, and contributing to the wallet's aesthetic and tactile qualities. Positioned adjacent to the second leather layer, the spring bar layer introduces a mechanism for adjusting the wallet's capacity and securing its contents. This layer is composed of a flexible, resilient material that exerts a variable force, adapting to the volume of items stored within the wallet. The second leather layer is not merely a duplication of the outer shell but a strategic addition that enhances the wallet's usability and durability. It is crafted from leather that complements the outer shell, maintaining the wallet's luxurious feel while providing an extra level of protection and compartmentalization for the wallet's contents. The spring bar layer is configured to exert a variable force based on the thickness of the objects placed between it and the second leather layer. This adaptability allows the wallet to securely hold items of various sizes, from a single card to multiple folded bills, without the risk of them slipping out.

Together, these layers work synergistically to enhance the wallet's performance. The second leather layer offers additional space for storage and contributes to the wallet's structural integrity. The spring bar layer, with its variable force mechanism, ensures that the items stored within this space are held securely, regardless of their quantity or size. This arrangement not only maximizes the wallet's utility but also maintains its slim profile, avoiding the bulkiness typical of wallets that attempt to increase capacity. Traditional wallets often struggle to balance capacity with security and slimness. A spring bar mechanism addresses this challenge by providing a flexible, secure way to hold items of varying sizes without compromising the wallet's form or function. This design improvement not only enhances the user experience by providing a more versatile and secure storage solution but also elevates the wallet's aesthetic appeal through the integration of high-quality materials. This configuration sets a new standard in wallet design, offering users a sophisticated, practical, and aesthetically pleasing accessory.

The second leather layer includes a second cutout 118 corresponding to the spring bar layer. The second cutout in the second leather layer is a precisely shaped opening that aligns with the underlying spring bar layer. This particular leather cutout is designed to lay on top of the metal spring bar itself and protect cards from getting scratched by the metal when inserted into the wallet. The leather acts as a soft buffer. This cutout allows direct access or interaction with the spring bar, enabling it to function as intended without obstruction. Its existence is important for the operational efficacy of the spring bar mechanism, facilitating the variable force application to the contents stored within the wallet. This cutout is designed to match the dimensions and location of the spring bar layer beneath it. The precision in alignment ensures that the force exerted by the spring bar can be effectively transmitted to the contents of the wallet, securing them in place. The cutout's edges are finished to maintain the integrity and aesthetic appeal of the leather, ensuring that it contributes to the wallet's overall design quality.

The second cutout serves as a critical interface between the user and the spring bar mechanism. By allowing the spring bar layer to adjust according to the volume of items stored, it directly contributes to the wallet's adaptability and functionality. This interaction not only ensures that items of varying sizes can be securely accommodated but also enhances the user experience by making the wallet more versatile and responsive to the user's needs. This element improves over prior art, where the capacity to securely hold items within a wallet is often fixed or limited to specific sizes. Traditional wallets lack the dynamic adaptability offered by the spring bar mechanism, which is effectively enabled by this second cutout. By integrating this feature, the wallet not only becomes more flexible in terms of what it can securely store but also more intuitive and satisfying for the user to interact with. The second cutout addresses common frustrations associated with fixed-capacity wallets, offering a solution that is both elegant and functional.

The spring bar layer 116 is configured to exert a variable force on the object disposed within the pocket based on a thickness of the object, thereby accommodating objects of various sizes. The spring bar layer is a flexible mechanism integrated into the wallet's structure, specifically within or adjacent to the pocket where items are stored. Its primary function is to apply pressure on the stored items, ensuring they are held securely within the wallet. The unique characteristic of the spring bar is its ability to adjust the force it exerts based on the thickness of the objects placed in the pocket, providing a tailored fit that prevents items from slipping out while making them easily accessible when needed. The spring bar is designed to flex or compress in response to the volume of items it encounters. This means that when a thicker object or a larger quantity of items is inserted into the pocket, the spring bar compresses to accommodate the increased volume and exerts a greater force to hold these items in place. Conversely, with fewer or thinner items, the spring bar extends less, applying a lighter force sufficient to keep these items secure without damaging them. This adaptability allows the wallet to function effectively across a broad range of use cases, from holding a single identification card to storing several credit cards and folded notes. The design ensures that regardless of how much or how little the wallet is carrying, the contents are held firmly in place. The spring bar layer interacts with the wallet's overall design by providing a dynamic storage solution that enhances the user experience. This mechanism ensures that the wallet remains slim and compact without sacrificing its ability to securely store a variety of items. The spring bar's variable force mechanism is integral to the wallet's promise of versatility and security, ensuring that items are not only well-organized but also protected against accidental loss.

A pocket 120 is formed between the outer leather shell. This space is configured to serve as a secure and accessible compartment for storing items such as cards, currency, and other personal belongings. The pocket is a compartment created by the strategic positioning of the second leather layer adjacent to the outer leather shell. This design choice utilizes the space between these layers to offer additional storage without compromising the wallet's slim profile. The pocket's accessibility and capacity are carefully considered to enhance user convenience and satisfaction. This pocket is designed to be both discreet and easily accessible, ensuring that items stored within are secure yet readily available when needed. The dimensions of the pocket are tailored to accommodate commonly carried items, such as credit cards and folded bills, making it a versatile addition to the wallet's storage options. The construction of the pocket, leveraging the natural flexibility and durability of leather, ensures that it can expand slightly to fit the items it holds while maintaining the wallet's overall form.

The pocket interacts with the other components, such as the spring bar layer, to secure the items placed within. The pocket's position between the outer leather shell and the second leather layer not only optimizes space utilization within the wallet but also contributes to the wallet's aesthetic appeal by maintaining a sleek and uncluttered exterior. This strategic placement ensures that the wallet remains compact and lightweight, even when fully utilized. Conventional wallets often lack the flexibility and innovation to provide additional storage without increasing bulkiness. This pocket's design cleverly utilizes the existing space within the wallet's structure, offering enhanced storage capabilities without altering the wallet's slim profile. Furthermore, the pocket's secure yet accessible nature addresses common user frustrations with traditional wallets, where items can be difficult to retrieve or too loosely held.

The second leather layer is configured to retain the object disposed within the wallet under a force applied by the spring bar layer. This configuration ensures that objects placed within the wallet are held firmly in place by a variable force exerted by the spring bar layer, accommodating a range of item sizes with efficiency and reliability. The second leather layer serves as a flexible yet resilient component of the wallet's interior, positioned to interface directly with items stored inside. Its primary role is to provide a secure holding area for items such as cards, cash, or other essential personal effects. The important aspect of this layer is its interaction with the spring bar layer, which applies a variable force to objects placed between it and the second leather layer, ensuring they are securely retained within the wallet. The spring bar layer is engineered to apply a force that adapts based on the thickness of the object it is securing. This means that whether the wallet contains a single card or multiple cards and cash, the force exerted by the spring bar adjusts to maintain a secure grip without damaging the contents. The second leather layer, in concert with the spring bar, provides a snug environment that keeps items from slipping out, even when the wallet is opened or held upside down. The second leather layer is also meant to not damage the contents, as described above. This retention capability is crucial for a wallet's primary function of safely carrying personal items. The second leather layer acts as a reactive surface that accommodates the variable force from the spring bar, ensuring objects are held securely. This system adapts to the user's needs, allowing for a flexible storage solution that does not compromise security or the integrity of the stored items. This design significantly improves upon traditional wallet designs, which often rely on static compartments with limited flexibility in accommodating varying volumes of contents. The spring bar layer, working in tandem with the second leather layer, introduces a dynamic storage solution. This approach allows the wallet to securely hold a wide range of item sizes without the risk of them becoming loose or falling out, enhancing the wallet's functionality and user satisfaction.

The wallet further includes a first plastic layer 122 configured for stitching reinforcement. The first plastic layer configured to reinforce the areas subjected to stitching. This reinforcement layer aims to provide additional strength and support to the seams, which are often the first points of failure in wallets due to the stress and strain of daily use. By bolstering these areas, the wallet achieves a higher degree of durability and resistance to wear. This plastic layer is thin and flexible, allowing it to be seamlessly incorporated into the wallet's design without adding unnecessary bulk or stiffness. It is positioned in such a way that it underlies the areas where stitching occurs, effectively distributing the tension and stress exerted on the seams during use. This distribution helps prevent the pulling and tearing of the material that typically leads to seam failure. By reinforcing the stitched areas, this layer not only enhances the structural integrity of the wallet but also ensures that the aesthetic appearance is maintained over time. The reinforcement layer works in conjunction with the wallet's other materials, such as the leather and microfiber layers, to create a cohesive and durable product. Its presence is particularly important in areas of the wallet that experience frequent or heavy use, such as the opening flap or card slots, where the integrity of the stitching is vital for the wallet's overall performance. Traditional wallets often overlook the need for reinforced stitching, leading to premature wear and tear and a shortened product lifespan. By addressing this issue directly, the described wallet offers a solution that significantly extends the durability of the product without compromising its design or functionality. The first plastic layer ensures that the wallet can withstand the rigors of daily use while maintaining its aesthetic appeal and structural integrity.

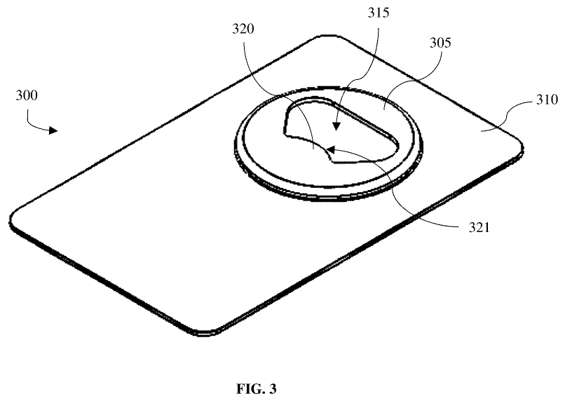

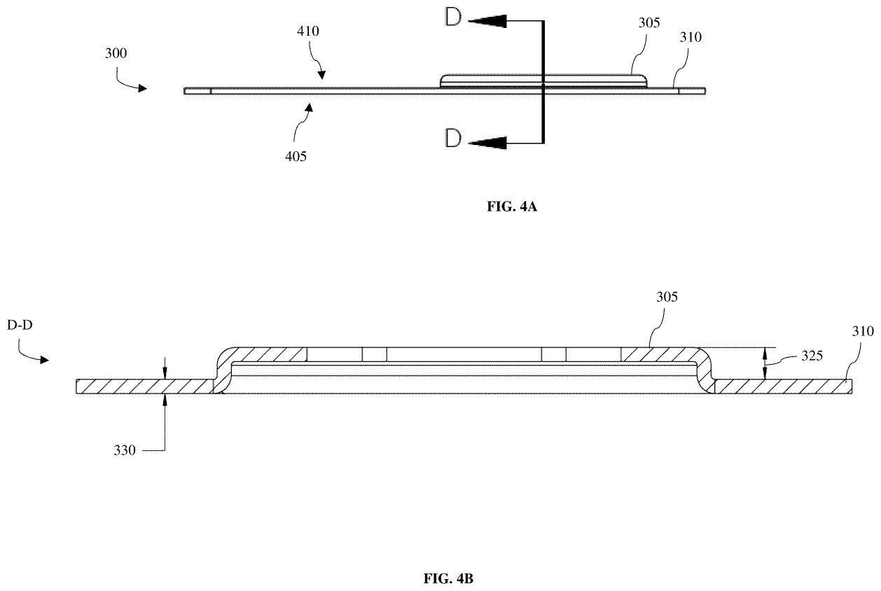

The wallet further includes a second plastic layer 124, or intermediate casing, having a portion with a leather material 126 on a backward facing side, or rear facing side 129, of the intermediate casing. The intermediate casing 124 is disposed within the main body between the front surface 104 of the main body 101 and the first surface (405 in FIG. 4A) of the rigid insert. The first surface 405 faces the interior of the main body. The base plate 310 also includes a second surface 410 (also shown in FIG. 4A), which faces the rear surface of the main body. The rigid insert is configured to be disposed proximate to the intermediate casing. The leather material includes an exposed surface 127 configured to substantially align with the raised platform 134, or first substantially planar surface, of the rigid insert. The exposed surface 127 is visible through the aperture 136 in the rigid insert 110. The cavity 140 formed between the portion of the second surface of the rigid insert that defines the raised platform and the intermediate casing is a structural space specifically configured to provide clearance for engaging a bottle cap during operation of the integrated bottle opener. This cavity serves a functional purpose directly related to the mechanical action of the bottle opener. It is positioned beneath the raised platform, occupying the space between the underside of the rigid insert's second surface and the adjacent surface of the intermediate casing. This cavity is necessary to accommodate the lower edge of a bottle cap when it is inserted into the aperture defined in the raised platform. As a user positions a bottle cap against the arcuate edge of the catching lip within the aperture, the cap's lower rim must be able to recess into the wallet body to allow for secure engagement and leverage. The cavity provides this clearance by forming a void that permits the cap to seat properly without interference from underlying structural layers. This structural feature significantly improves the operability of the integrated bottle opener. In prior art designs, integrated openers often lacked sufficient clearance within the wallet body, making bottle cap engagement cumbersome or ineffective. By incorporating a dedicated cavity beneath the bottle opener, this design allows the cap to nest securely within the wallet body during use, ensuring full engagement with the catching lip and maximizing leverage. This approach enhances the reliability and efficiency of the opener while maintaining the slim form factor of the wallet, achieving a functional balance between mechanical performance and compact design.

The second plastic layer 124 serves as a foundational component within the wallet, designed to provide additional support and maintain the wallet's shape. The unique aspect of this layer is the inclusion of a leather material on its backward facing side, which faces towards the interior of the wallet. This design choice not only leverages the durability and rigidity of plastic but also incorporates the luxurious feel and traditional appeal of leather, offering a multi-faceted enhancement to the wallet. This plastic layer is strategically engineered to be both lightweight and sturdy, ensuring that it adds minimal bulk while contributing significantly to the wallet's overall strength. The backward facing side, adorned with leather, is crafted to present the leather's texture and warmth to the wallet's interior, enriching the user's tactile experience. The presence of leather on the plastic layer also aids in creating a cohesive aesthetic throughout the wallet, seamlessly blending the functional aspects with traditional design elements. Within the wallet's structure, the second plastic layer acts as a bridge between the functional needs for durability and the aesthetic desire for quality materials. Its placement is carefully considered to maximize the benefits of both the plastic and leather components. The plastic provides a robust framework, helping to protect and preserve the wallet's shape and contents, while the leather enhances the internal appearance and feel, elevating the perceived value and luxury of the wallet. The second plastic layer addresses the common compromise between durability and luxury by combining them into a single, integrated solution. It enhances the wallet's structural integrity without sacrificing the classic appeal of leather, offering users a product that is both practical and prestigious.

The specification of plastic layers is intended to represent a broad category of materials with properties suitable for achieving specific design objectives, such as structural integrity, flexibility, and aesthetic enhancement. This categorization is not limited exclusively to conventional plastics but extends to a wide array of synthetic and composite materials that can provide similar or improved functionalities. These alternative materials may include, but are not limited to, advanced polymers, bio-based plastics, composite materials integrating natural fibers, and recyclable or biodegradable plastics, each selected for their unique characteristics and contributions to the wallet's overall performance and sustainability profile. The selection and integration of these materials into the wallet are conducted with particular attention to ensuring that the wallet retains essential qualities such as durability, functionality, and aesthetic appeal. Each alternative material is evaluated not only for its physical and mechanical properties but also for its environmental impact, ensuring that the wallet represents a forward-thinking approach to design that prioritizes innovation, user satisfaction, and sustainability.

The main body further includes a filler layer 128 configured to mate with the second substantially planar surface, or base plate, of the metal layer such that the filler layer occupies an interstitial space between the first substantially planar surface and the second substantially planar surface, resulting in a filler surface that is substantially flush with the first substantially planar surface. This creates a seamless and smooth transition between the filler layer and the first substantially planar surface 134 of the metal layer, as illustrated in FIG. 2A. The filler layer is a specifically engineered component that fills the gap or space between the first and second substantially planar surfaces within the metal layer of the wallet. Its primary function is to provide a continuous, level surface that aligns with the first planar surface, thereby eliminating any recess or protrusion that could detract from the wallet's sleek profile or snag on objects. The filler layer is precisely contoured to match the dimensions and shape of the second planar surface, ensuring a perfect fit. This precise alignment is crucial for the filler layer to effectively perform its intended function without altering the wallet's overall thickness or form. The filler layer fills the space between the raised first planar surface and the base second planar surface. This not only contributes to a uniform appearance but also reinforces the wallet's structure by providing additional stability and support where the metal layer is extruded. The upper surface of the filler layer is designed to be level with the first planar surface. Achieving this flush alignment is essential for maintaining the wallet's smooth exterior, enhancing both the tactile and visual experience of handling the wallet. The filler layer supports the metal layer's structural elements, ensuring that the wallet remains robust and resistant to deformation under stress. Furthermore, by filling the interstitial space, the filler layer prevents the accumulation of debris and makes the wallet easier to clean and maintain.

This filler layer may be composed of materials selected for their durability, resilience, and compatibility with the wallet's overall design and functionality. While specific materials are identified herein, it is to be understood that the scope of the present disclosure is not limited to these materials alone but extends to any suitable substitutes that fulfill the intended purpose of the filler layer. The present embodiment includes paperboard. However, the filler layer may include other materials such as ethylene-vinyl acetate (EVA), polyurethane (PU) foam, silicone rubber, thermoplastic polyurethane (TPU), cork, and/or recycled rubber. Materials are chosen not only for their physical properties but also for their ability to integrate seamlessly with the wallet's design, ensuring that the filler layer contributes positively to the wallet's overall form and function. It should be understood that the examples of materials provided herein are for illustrative purposes and do not limit the invention to these specific materials. The scope of the present disclosure encompasses any materials that offer similar properties and benefits as those described, allowing for future material innovations and technologies to be incorporated into the filler layer's design.

A second pocket is formed between the first substantially planar surface and the second plastic layer having a portion with a leather material. The leather material is visible through the opening of the metal layer. The interaction between the metal layer's openings and the underlying leather material creates a dynamic visual effect that elevates the wallet's design. This feature not only highlights the quality of the leather used but also demonstrates attention to detail in the wallet's construction. The contrast between the sleek, industrial feel of the metal and the warm, natural texture of the leather enriches the user's sensory experience with the product.

The main body 101 further includes a back leather cover 130, or rear out casing, including a circular cutout corresponding to the first substantially planar surface of the metal layer for accessing the bottle opener on a back side of the wallet. This element is configured to allow direct access to the integrated bottle opener from the wallet's back side, providing a seamless and intuitive user experience. The back leather cover serves as the outermost layer on the wallet's back side. The key feature of this cover is a circular cutout precisely positioned to coincide with the first substantially planar surface of the metal layer, where the bottle opener is located. This design choice ensures that the functionality of the bottle opener is accessible without compromising the wallet's structural integrity or visual coherence. This component is crafted from high-quality leather, chosen for its durability, tactile appeal, and aesthetic quality. The leather cover not only protects the wallet's contents but also contributes to its overall luxury and elegance. The cutout aligns perfectly with the bottle opener's position within the metal layer. Its circular shape is both functional and visually appealing, providing a clear indication of the bottle opener's access point while maintaining the design's sleek and cohesive appearance. The back leather cover and its circular cutout interact seamlessly with the metal layer and the integrated bottle opener, ensuring that this functional element is easily accessible. This design approach enhances the wallet's usability, allowing the user to utilize the bottle opener without the need to open the wallet or remove contents. The placement of the cutout also ensures that the wallet's aesthetic appeal is not compromised, blending functionality with design in a manner that is both intuitive and stylish.

It should be understood that references to the leather layers may encompass a wide variety of materials beyond traditional leather. The specification of leather is for illustrative purposes and does not preclude the incorporation of alternative materials that can fulfill similar structural, aesthetic, or functional roles within the wallet's construction. These alternative materials may include, but are not limited to, synthetic leathers such as polyurethane (PU) or polyvinyl chloride (PVC), natural fiber-based fabrics, engineered textiles, sustainable materials like cork, and recycled content fabrics, each offering distinct benefits in terms of durability, environmental impact, aesthetic appeal, and cost-effectiveness. The incorporation of such materials into the wallet's design is carefully considered to ensure that the final product maintains the desired qualities of durability, functionality, and aesthetic appeal. Each alternative material is selected based on its ability to complement the wallet's overall design principles, providing a versatile and adaptable solution that can cater to a broad range of consumer preferences and requirements.

The plurality of magnets is configured to align with and attach to a magnet in an electronic device. This feature consists of at least one magnet embedded within the wallet, arranged to correspond with the magnetic attachment points or magnets arranged in a manner that is configured to technology safe, which present in certain electronic devices, such as, but not limited to, an iPhone® or other mobile devices. Technology safe magnets and/or magnetic safety technology, typically involves the use of magnets in devices and accessories to enable secure attachment and alignment for charging or mounting purposes. The magnets ensures a strong and stable connection between the wallet and the device. The arrangement and polarity of the magnets are calibrated to ensure compatibility with the magnet arrangement in the electronic device. This involves precise positioning to align with the magnetic fields and attachment points on the electronic device, facilitating a secure and correct attachment every time. The interaction between the wallet's magnets and the electronic device's technology safe magnet offers a streamlined user experience, allowing for easy attachment and detachment without compromising the security of the connection. This feature not only enhances the practicality of the wallet by extending its functionality beyond traditional storage but also protects the electronic device by ensuring a secure fit that prevents slipping or misalignment.

The wallet may further include an RFID-blocking layer integrated within the wallet, providing security against unauthorized scanning of cards. This feature addresses growing concerns over digital theft and privacy, ensuring that sensitive information stored on cards such as credit cards, passports, and identification cards remains secure from illicit RFID scanning attempts. An RFID-blocking layer is a protective shield incorporated into the wallet's structure. It is made from materials capable of blocking or disrupting radio waves, thereby preventing RFID readers from accessing the data stored on RFID-enabled cards contained within the wallet. This layer acts as a barrier against attempts to illicitly scan or skim personal information. The RFID-blocking layer typically consists of materials like metal fabrics or foils that are effective at interrupting radio frequency signals. These materials are selected for their ability to reflect or absorb radio waves, ensuring that any attempt to access the data on RFID-enabled cards is thwarted. This layer is seamlessly integrated into the wallet's design, sandwiched between the outer leather shell and the interior lining or compartments. Its placement is configured to ensure comprehensive coverage so that all areas of the wallet where cards are stored are protected.

The RFID-blocking layer works in concert with the wallet's other components to provide a multifunctional accessory that offers both physical storage and digital security. Its integration does not affect the wallet's aesthetic appeal or functionality. Instead, it adds a significant value proposition by safeguarding the user's personal information against electronic pickpocketing, a growing concern in an increasingly digital world. The RFID-blocking layer within the wallet improves over traditional wallet designs, which offer no protection against the digital theft of personal information. As RFID technology becomes more prevalent in credit cards and identification documents, the risk of unauthorized scanning grows. Traditional wallets leave these RFID-enabled items vulnerable to skimming, a method used by thieves to steal personal information remotely. By integrating RFID-blocking technology, this wallet design addresses a critical modern security concern, providing users with peace of mind knowing that their sensitive information is protected against unauthorized access. This feature highlights the wallet's evolution from a simple storage solution to a sophisticated accessory that combines functionality with advanced security measures.

With reference to FIG. 2A, the metal layer further includes a plurality of magnets 132 disposed on the second surface of second substantially planar surface, or base plate, at least partially around the first substantially planar surface, configured for removably attaching to a magnetic surface. This magnetic attachment assembly enables the wallet to be removably attached to magnetic surfaces, offering additional functionality beyond traditional wallet designs. This feature consists of multiple magnets strategically embedded in a predefined pattern within the wallet's second substantially planar surface. The predefined pattern of the plurality of magnets in the magnetic attachment assembly is a substantially ring-shaped configuration, meaning that the magnets are arranged in a circular or near-circular layout around a central region. These magnets are positioned in such a way that they encircle, at least in part, the raised first substantially planar surface, which houses the bottle opener. The primary function of these magnets is to facilitate a removable attachment of the wallet to any compatible magnetic surface, thereby increasing the wallet's versatility and user convenience. By positioning the magnets around the first planar surface, the design maximizes the use of space within the wallet while also leveraging the structural integrity provided by the metal layer. This predefined pattern and placement ensures that the magnets do not interfere with the wallet's other functionalities, such as the bottle opener. Users can attach the wallet to magnetic surfaces for convenience, security, or to simply reduce the risk of loss or theft. This feature is particularly useful in scenarios where keeping the wallet within reach but out of the way is desirable.

The metal layer 110, or rigid insert, is positioned within the wallet such that the first substantially planar surface 134 of the metal layer is substantially flush with an outer surface of the back leather cover, or the rear surface 106 of the main body 101, facilitating a secure and stable attachment to magnetic objects. This arrangement not only contributes to the wallet's sleek and refined aesthetic but also plays a crucial role in facilitating a secure and stable attachment to magnetic objects. This design aspect involves the precise alignment of the metal layer's first substantially planar surface with the wallet's back leather cover. The metal layer, which houses functional components like the integrated bottle opener and magnets for attachment, is embedded in such a way that its top surface is level with the leather cover's exterior. This flush alignment ensures that there are no protrusions or recesses on the wallet's surface, maintaining a smooth and unobstructed profile. The term “flush” denotes that the metal layer's surface and the back leather cover's outer surface, or rear surface 106 of the main body, are on the same plane, without any part of the metal layer extending above or sinking below the leather's surface. This alignment is critical for both aesthetic reasons and functional efficacy, particularly concerning the wallet's ability to attach to magnetic surfaces. The flush positioning of the metal layer enhances the wallet's magnetic functionality. With the magnets embedded within the metal layer positioned close to the wallet's surface, their magnetic field's strength and reach are maximized, allowing for a stronger and more stable attachment to magnetic objects or surfaces.

The flush alignment of the metal layer with the back leather cover ensures that the wallet remains compact and easy to carry while also maximizing the efficiency of the embedded magnets, enabling the wallet to securely attach to magnetic surfaces or objects, such as magnetic mounts or strips, enhancing the wallet's utility. This design feature improves over traditional wallet designs, which typically do not consider the integration of metal components for magnetic attachment purposes. By ensuring that the metal layer is flush with the wallet's back leather cover, this wallet design not only maintains a sleek and elegant appearance but also enhances the wallet's functionality by leveraging magnetic attachment capabilities. This approach allows for a more versatile use of the wallet, extending its utility beyond mere storage to include secure attachment to magnetic surfaces.

The bottle opener is configured with a leverage-enhancing contour having a substantially ovular shape with a narrow handle portion, allowing for efficient cap removal with minimal effort. This design adopts a substantially ovular shape with a distinct narrow handle portion, which is key to facilitating the removal of bottle caps with minimal effort. The design of the bottle opener is focused on ergonomic efficiency, utilizing a contour that enhances leverage when engaging and lifting bottle caps. The ovular shape, coupled with a narrower handle portion, is specifically tailored to fit comfortably in the user's hand, providing a natural grip that optimizes the force applied during use. The substantially ovular shape is chosen for its ergonomic benefits, providing a broad surface area for the user's fingers to rest against while applying pressure. The ovular contour ensures that the force exerted by the user is distributed evenly, reducing strain and increasing the effectiveness of the bottle opener. The narrow handle portion serves to increase the torque applied during the cap removal process. This element allows the user to apply a greater force with less physical effort, making the bottle opener more efficient at its task.

The bottle opener's design is seamlessly integrated into the wallet's structure, maintaining the accessory's compact and sleek profile while offering high utility. The leverage-enhancing contour works in harmony with the wallet's overall design, ensuring that the functionality of the bottle opener does not compromise the wallet's aesthetic appeal or portability. This integration demonstrates a balance between form and function, providing users with a practical tool that remains unobtrusive and elegant. The leverage-enhancing contour improves over traditional bottle openers, which may not always consider ergonomic efficiency or may require more effort to operate effectively. This design feature with its ovular shape and narrow handle portion allows for efficient cap removal with minimal effort, addressing common user complaints regarding difficulty or discomfort with conventional openers. By integrating this ergonomically optimized bottle opener into the wallet, the design not only enhances the wallet's utility but also introduces a level of convenience and ease of use that sets it apart from existing products in the market. This approach integrates tools into everyday items.

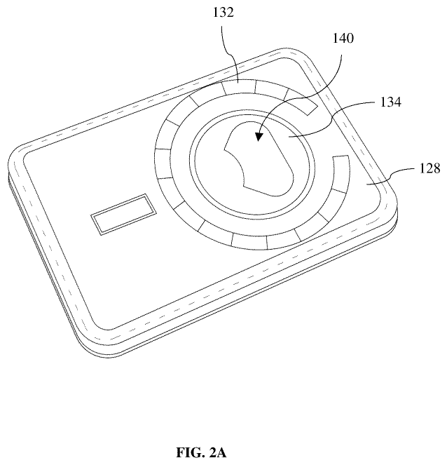

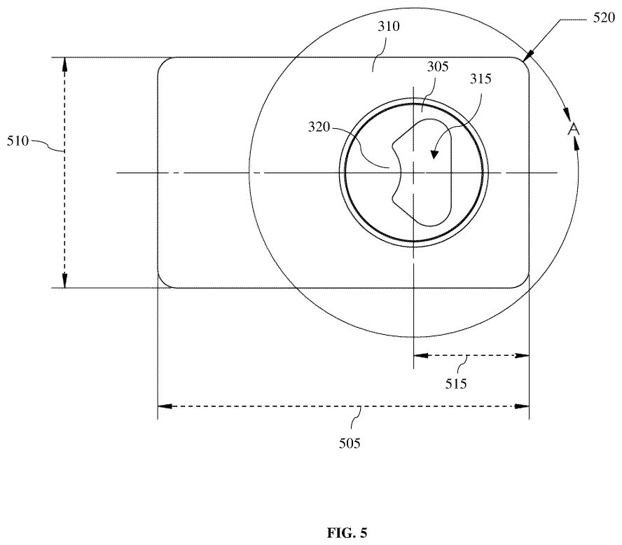

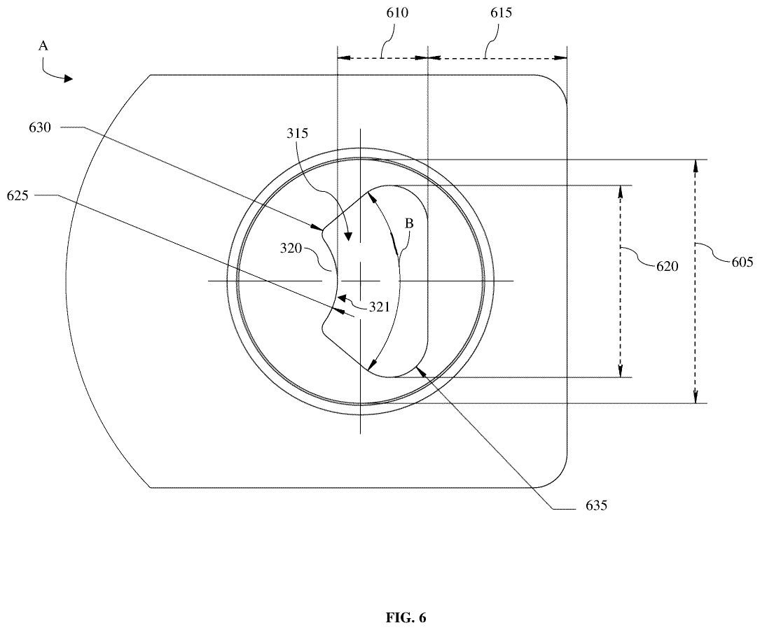

Referring now to FIGS. 3 through 6, FIG. 3 is a perspective view of a metal layer 300, or rigid insert, of the wallet with an integrated bottle opener, according to an example embodiment. FIG. 4A is a side view of a metal layer of the wallet with an integrated bottle opener, according to an example embodiment. FIG. 4B is a cross-section D-D of a side view of the metal layer, according to an example embodiment. FIG. 5 is a front view of a first substantially planar surface of the metal layer, according to an example embodiment. FIG. 6 is a front view of the first substantially planar surface, according to an example embodiment. The metal layer is characterized by its robust construction and precision-engineered features, including a bottle opener and magnetic attachment points. This layer not only contributes to the wallet's structural integrity but also enhances its utility by integrating tools directly into the wallet's design. The metal layer is composed of high-grade metal, chosen for its strength, durability, and resistance to corrosion. Its design includes a first substantially planar surface extruded from a second substantially planar surface, creating a multi-level architecture within the wallet. A key feature of this metal layer is the integrated bottle opener, cleverly designed with an opening and a catching lip. This allows the wallet to serve an additional purpose beyond merely storing items, providing convenience to the user. Surrounding the bottle opener, the layer includes a plurality of magnets disposed on the second substantially planar surface. These magnets are intended for removably attaching the wallet to magnetic surfaces, offering enhanced security and versatility.

Structurally, it provides a rigid backbone to the wallet, enhancing its durability and protecting its contents. Functionally, the integrated bottle opener and magnetic attachment points introduce new utility aspects, making the wallet a more versatile accessory. Aesthetically, the metal's presence adds a modern, sophisticated touch to the wallet's design, appealing to users seeking functionality without compromising on style. Traditional wallets typically focus on material choices such as leather or fabric, which, while aesthetically pleasing, offer limited functionality. The metal layer's integration into the wallet introduces a new dimension of utility, allowing the wallet to serve additional purposes such as opening bottles and attaching to magnetic surfaces securely. The metal layer addresses the modern consumer's desire for multifunctional accessories, setting this wallet apart in the crowded market of personal accessories.

The metal layer, or rigid insert, includes a first substantially planar surface 305, or raised platform, extruded from a second substantially planar surface 310, or base plate. The first substantially planar surface is circular and at a first depth 325 above the second substantially planar surface. The second substantially linear planar surface has a thickness 330 of approximately 0.039 inches. The second substantially linear planar surface may include a thickness 330 of approximately 0.039 inches. The term “extruded” refers to a process or result where a shape is extended or pushed out from another to create a new form or surface. In this context, the first substantially planar surface being extruded from the second substantially planar surface means that the former projects above the latter, creating a raised area with a specific shape and depth relative to its base layer. The first substantially planar surface is circular and positioned at a specific depth above the second substantially planar surface. The circular shape is precise and deliberate, serving a functional purpose in the wallet's design, likely related to the integrated bottle opener. The choice of a circular form can be attributed to ergonomic and aesthetic considerations, facilitating ease of use and contributing to the wallet's overall visual appeal. The second substantially planar surface is the base layer from which the first surface is extruded. It serves as the foundation for the raised circular surface and is integral to the structural integrity and functionality of the metal layer. The relationship between the two surfaces creates a multi-level effect, adding depth and complexity to the wallet's design.

The extrusion of the first planar surface from the second creates a functional and aesthetic feature within the wallet. This multi-level structure is not merely decorative; it plays a critical role in the functionality of the integrated bottle opener. The depth and shape of the first planar surface are crucial for enabling the bottle opener to effectively engage with and remove bottle caps. The first planar surface also provides enough depth for the magnet ring to sit on top and become flush with the top of the bottle opener. Furthermore, this design element contributes to the tactile and visual distinctiveness of the wallet, enhancing its overall user appeal.

The first substantially planar surface includes an opening, or an aperture, 315 and a catching lip 320 defining a bottle opener. The catching lip includes an arcuate edge 321. The arcuate edge is a curved portion of the aperture within the rigid insert of the bottle opener assembly, specifically designed to engage the underside of a bottle cap and facilitate its removal. This edge forms part of the contoured boundary of the aperture and is shaped to conform to the curvature of a standard bottle cap, allowing for effective engagement when a user applies force to pry the cap off. The curvature of the arcuate edge ensures that contact with the bottle cap is distributed smoothly along its surface, reducing the likelihood of slippage and improving the efficiency of the opening process. These features collectively define the functionality of a bottle opener. The catching lip of the bottle opener is configured to engage with and assist in removal of bottle caps. The opening allows the bottle cap to be fitted onto the opener, while the catching lip is precisely designed to catch the edge of the bottle cap, enabling effective leverage for cap removal. The opening is a cutout within the first substantially planar surface. Its size and shape are optimized to accommodate the rim of a standard bottle cap, ensuring a secure fit. The opening's placement within the circular planar surface is crucial for maximizing leverage and ease of use when engaging a bottle cap. Located at the edge of the opening, the catching lip protrudes slightly, creating a point of contact for the underside of the bottle cap. This lip is engineered to provide the necessary leverage to pry open the bottle cap with minimal effort. The precision in its design is evident in its ability to securely engage the cap and assist in its removal without slipping or damaging the cap or the wallet. The integration of the opening and catching lip into the first substantially planar surface of the metal layer transforms the wallet into a multi-functional accessory. This design allows the user to leverage the wallet's sturdy structure to easily open bottles, adding a layer of convenience and utility. The circular shape of the first planar surface, combined with the ergonomic positioning of the opening and catching lip, ensures that the bottle opener is both effective and easy to use, enhancing the user's experience.

Referring now to FIG. 5, a top view of the rigid insert is shown, according to an example embodiment. The figure depicts a rigid insert featuring a raised platform 305 that extends outwardly from a base plate 310. The raised platform 305 is substantially circular and provides structural support for the bottle opener functionality. The raised platform defines an aperture 315, which is centrally positioned and shaped to engage a bottle cap for removal. The aperture 315 includes a contoured edge that conforms to the shape of a bottle cap, allowing for efficient engagement and prying functionality.

A catching lip 320 is disposed along a portion of the contoured edge of the aperture 315. The catching lip 320 includes the arcuate edge that facilitates engagement with the underside of a bottle cap, enabling the user to apply leverage for cap removal. The design of the catching lip optimizes the force distribution when prying open a bottle cap, reducing slippage and ensuring effective operation.

FIG. 5 also includes various dimensional annotations that indicate the overall dimensions of the bottle opener assembly relative to the card holder wallet. The width 505 of the assembly is approximately 3.46 inches, while the length 510 is approximately 2.15 inches. The distance 515, which is approximately 1.08 inches, represents the placement of the aperture relative to the overall structure, ensuring proper alignment for functionality. The four rounded corners 520 include a radius of 0.18 inches, contributing to improved durability, resistance to wear, and an aesthetically integrated design. The embodiment depicted in FIG. 5 demonstrates an optimized configuration of a bottle opener integrated into a compact card holder wallet. The raised platform and strategically positioned aperture allow for effective bottle cap removal while maintaining a slim and functional profile suitable for everyday use.

Referring now to FIG. 6, a detailed top view A of the rigid insert in FIG. 5 is shown, according to an example embodiment. This figure provides additional dimensional details of the aperture 315 and the catching lip 320 formed within a raised platform 305. Angle B is approximately 80°, defining an operational region within the aperture 315 where the bottle cap engagement occurs. This angular section enhances the bottle-opening efficiency by guiding the cap along a controlled path as force is applied. The total diameter 605 of the aperture is approximately 1.27 inches, ensuring compatibility with standard bottle caps. The horizontal distances 610 and 615 are approximately 0.47 inches and 0.73 inches, respectively, and define the relative positioning of the aperture components within the surrounding structure. The height 620 of the aperture is measured as approximately 1.00 inch. Radius 625, which is approximately 0.36 inches, defines the curvature of arcuate edge 321. Radius 630, which is approximately 0.05, defines the curvature of the bottom corners of the aperture. Radius 635, which is approximately 0.20 inches, defines the curvature of the top corners of the aperture. These radius values contribute to the ergonomics of the bottle opener, ensuring ease of use and durability over time.

The embodiment depicted in FIG. 6 showcases a precisely engineered bottle opener integrated within a compact card holder wallet. The combination of a raised platform, a contoured aperture, and a strategically positioned catching lip provides an efficient and reliable mechanism for bottle cap removal. The dimensional details ensure compatibility with standard bottle caps while maintaining a slim and functional profile suitable for everyday use.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A card holder wallet comprising:
a main body having a front surface and a rear surface;
a pocket disposed between the front surface and the rear surface;
a bottle opener disposed within the rear surface of the main body, the bottle opener comprising:
a rigid insert positioned within the main body;
an aperture formed through the rigid insert and the rear surface, the aperture having an arcuate edge configured to engage a bottle cap;
a magnetic attachment assembly embedded within the main body, the magnetic attachment assembly comprising a plurality of magnets arranged in a predefined pattern.

2. The card holder wallet of claim 1, wherein the magnetic attachment assembly is disposed between the bottle opener and the rear surface.

3. The card holder wallet of claim 1, wherein the predefined pattern of the plurality of magnets in the magnetic attachment assembly is a substantially ring-shaped configuration.

4. The card holder wallet of claim 1, wherein the rigid insert comprises:
a base plate having a first surface and a second surface, the first surface facing an interior of the main body and the second surface facing the rear surface of the main body;
a raised platform formed on the base plate and extending outwardly from the second surface of the base plate;
the aperture defined within the raised platform, the aperture including:
a contoured edge shaped to engage a bottle cap; and
a catching lip disposed along a portion of the contoured edge, the catching lip comprising the arcuate edge.

5. The card holder wallet of claim 4, wherein the raised platform is substantially circular.

6. The card holder wallet of claim 4, wherein the plurality of magnets is disposed in the predefined pattern substantially around the raised platform.

7. The card holder wallet of claim 4, further comprising an intermediate casing disposed within the main body between the front surface of the main body and the first surface of the rigid insert, the intermediate casing comprising an exposed surface on a rear facing side of the intermediate casing, the exposed surface configured to substantially align with the raised platform of the rigid insert and wherein the exposed surface is visible through the aperture in the rigid insert.

8. A card holder wallet comprising:
a main body having a front surface and a rear surface, the main body comprising:
a rigid insert disposed within the main body between the front surface and the rear surface, the rigid insert comprising:
a base plate having a first surface and a second surface, the first surface facing an interior of the main body and the second surface facing the rear surface of the main body;
a raised platform formed on the base plate and extending outwardly from the second surface of the base plate;
an aperture defined within the raised platform, the aperture including:
a contoured edge;
a catching lip disposed along a portion of the contoured edge; and
a plurality of magnets disposed on the second surface and arranged in a predefined pattern substantially around the raised platform.

9. The card holder wallet of claim 8 comprising a filler layer disposed adjacent to second surface between the rigid insert and the rear surface of the main body, wherein the filler layer comprises a first cutout corresponding to the raised platform of the rigid insert and a second cutout corresponding the plurality of magnets.

10. The card holder wallet of claim 9 comprising a rear outer casing comprising a second cutout corresponding to the raised platform of the rigid insert, and wherein the rear outer casing comprises the rear surface of the main body.

11. The card holder wallet of claim 10 comprising an intermediate casing disposed between the front surface of the main body and the first surface of the rigid insert, the intermediate casing comprising an exposed surface on a rear facing side of the intermediate casing, the exposed surface configured to substantially align with the raised platform of the rigid insert and wherein the exposed surface is visible through the aperture in the rigid insert.

12. The card holder wallet of claim 11 further comprising a cavity formed between the portion of second surface of the rigid insert that defines the raised platform and the intermediate casing.

13. The card holder wallet of claim 12, wherein the card holder wallet further comprises:
an outer casing comprising the front surface of the main body; and
a pocket formed between the outer casing and the intermediate casing.

14. The card holder wallet of claim 13 further comprising a spring bar disposed adjacent to the pocket.

15. A card holder wallet assembly comprising:
an outer casing comprising a front layer, a middle layer, and an innermost liner;
a second layer disposed adjacent to the outer casing;
a pocket formed between the second layer and the outer casing;
a spring bar disposed adjacent to the second layer;
an intermediate casing comprising an exposed surface on a rear facing side of the intermediate casing;
a rigid insert disposed proximate to the intermediate casing, the rigid insert comprising a raised surface having an aperture with an arcuate edge configured to engage a bottle cap;
a magnetic attachment assembly disposed proximate to the rigid insert; and
a rear outer casing comprising an opening corresponding to the raised surface of the rigid insert.

16. The card holder wallet assembly of claim 15, wherein, in an assembled configuration, the exposed surface of the intermediate casing is visible through the aperture in the rigid insert.

17. The card holder wallet assembly of claim 15 further comprising a filler layer disposed adjacent the rigid insert and the magnetic attachment assembly, a first cutout corresponding to the raised surface of the rigid insert and a second cutout corresponding to the magnetic attachment assembly.

18. The card holder wallet assembly of claim 15 further comprising an RFID-blocking layer.
